(19) United States
(12) Patent Application Publication
(10) Pub. No.: US 2020/0106856 A1
(43) Pub. Date: Apr. 2, 2020

(54) COGNITIVE ALLOCATION OF MONITORING RESOURCES FOR CLOUD APPLICATIONS

(71) Applicant: International Business Machines Corporation, Armonk, NY (US)

(72) Inventors: Aly Megahed, San Jose, CA (US); Mohamed Mohamed, San Jose, CA (US); Samir Tata, Santa Clara, CA (US)

(21) Appl. No.: 16/147,136

(22) Filed: Sep. 28, 2018

(51) Int. Cl. H04L 29/08; H04L 12/26; G06F 17/30

(52) U.S. Cl. CPC H04L 67/327; H04L 43/08; G06F 17/3053; G06F 17/30598; G06F 17/30705; G06F 17/30867

(57) ABSTRACT

One embodiment provides a method comprising receiving a first set of data relating to a plurality of applications to be monitored, receiving a second set of data relating to one or more available resources, and determining one or more recommended allocations of the one or more available resources for monitoring the plurality of applications based on each set of data received. The first set of data includes unstructured data.

Embodiments of the present invention generally relate to cloud computing environments, and more particularly, to a system and method for cognitive allocation of monitoring resources for cloud applications.

### BACKGROUND

Workload resource consumption of a tenant in a cloud computing environment can include, but is not limited to, memory consumption, central processing unit (CPU) usage, storage, Input/Output Operations Per Second (IOPS). Workload resource consumption of tenants in cloud computing environments can vary over time.

### SUMMARY

One embodiment provides a method comprising receiving a first set of data relating to a plurality of applications to be monitored, receiving a second set of data relating to one or more available resources, and determining one or more recommended allocations of the one or more available resources for monitoring the plurality of applications based on each set of data received. The first set of data includes unstructured data.

These and other aspects, features and advantages of the invention will be understood with reference to the drawing figures, and detailed description herein, and will be realized by means of the various elements and combinations particularly pointed out in the appended claims. It is to be understood that both the foregoing general description and the following brief description of the drawings and detailed description are exemplary and explanatory of preferred embodiments of the invention, and are not restrictive of various embodiments of the invention, as claimed.

### BRIEF DESCRIPTION OF THE DRAWINGS

The subject matter which is regarded as embodiments of the invention is particularly pointed out and distinctly claimed in the claims at the conclusion of the specification. The foregoing and other aspects, features and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 illustrates an example monitoring resources allocation system, in one or more embodiments of the invention;

FIG. 4 illustrates an example monitoring resources allocation system, in one or more embodiments of the invention;

FIG. 5 illustrates an example workflow of a first example application weights system configured to determine a weight for each application of a plurality of applications to be monitored by analyzing structured data and unstructured data separately, in one or more embodiments of the invention;

FIG. 6 illustrates an example workflow of a second example application weights system configured to determine a weight for each application of a plurality of applications to be monitored by analyzing together structured data and unstructured data, in one or more embodiments of the invention;

FIG. 7 illustrates an example workflow of a first example metric weights system configured to determine a weight for each metric of a plurality of metrics to be monitored by analyzing structured data and unstructured data separately, in one or more embodiments of the invention;

FIG. 8 illustrates an example workflow of a second example metric weights system configured to determine a weight for each metric of a plurality of metrics to be monitored by analyzing together structured data and unstructured data, in one or more embodiments of the invention;

FIG. 9 is a flowchart of an example process for cognitive allocation of monitoring resources for a plurality of applications, in one or more embodiments of the invention; and

FIG. 10 is a high level block diagram showing an information processing system useful for implementing an embodiment of the present invention.

The detailed description explains the preferred embodiments of the invention, together with advantages and features, by way of example with reference to the drawings.

### DETAILED DESCRIPTION

Embodiments of the present invention generally relate to cloud computing environments, and more particularly, to a system and method for cognitive allocation of monitoring resources for cloud applications. One embodiment provides a method comprising receiving a first set of data relating to a plurality of applications to be monitored, receiving a second set of data relating to one or more available resources, and determining one or more recommended allocations of the one or more available resources for monitoring the plurality of applications based on each set of data received. The first set of data includes unstructured data.

For expository purposes, the term “cloud computing environment” as used herein generally refers to a cloud computing environment providing a shared pool of computing resources (e.g., networks, network bandwidth, servers, processing, memory, storage, applications virtual machines, services, licenses, etc.) available for consumption by one or more tenants.

For expository purposes, the term “workload resource consumption” as used herein generally refers to usage of one or more computing resources of a cloud computing environment by a tenant utilizing the one or more computing resources for its workload (e.g., one or more tasks that the tenant is assigned/tasked to perform, deploying an application, etc.).

For expository purposes, the term “cloud application” as used herein generally refers to an application deployed by a tenant utilizing one or more computing resources of a cloud computing environment.

Cloud computing is a strategic area of business at many companies now. It is beneficial for a cloud provider providing a cloud computing environment to monitor workload resource consumptions of tenants utilizing its cloud computing environment to address the needs of the tenants. For example, a cloud provider can monitor cloud applications deployed by tenants utilizing its cloud computing environment. Monitoring cloud applications, however, requires use of different resources (i.e., monitoring resources). Typically, only a limited amount/quantity of monitoring resources is available for use in monitoring cloud applications.

Conventional solutions for monitoring cloud applications include determining important/relevant metrics (e.g., memory usage, etc.) to be monitored and frequency of monitoring such metrics. Such conventional solutions, however, do not consider available unstructured data that might have a significant effect on optimal allocation of monitoring resources available for use in monitoring such metrics.

For example, a highly viewed broadcast event (e.g., a presidential debate, an awards ceremony, a sporting event, etc.) should be monitored for memory usage more often than a lesser viewed broadcast event because of a higher importance of actions to be taken for the highly viewed broadcast event. To realize importance/significance of an event and a high number of viewers that the event attracts, unstructured data relating to the event needs to be analyzed/monitored, such as unstructured data obtained from news outlets, social media, etc. To determine importance/significance of an event and in turn optimally allocate monitoring resources available for use in monitoring the event, it is necessary to use structured and unstructured data relating to the event. One or more embodiments of the invention provide a monitoring resources allocation system that a cloud provider can utilize to cognitively allocate monitoring resources available for use in monitoring multiple cloud applications deployed by tenants utilizing its cloud computing environment.

In one embodiment, the monitoring resources allocation system can be applied to resource-constrained environments that involve monitoring of things, such as Internet of Things (IoT) and cloud computing environments.

A cloud provider can use recommended allocations provided by the monitoring resources allocation system as a basis for recommendations to its tenants, thereby facilitating the cloud provider with upselling some of its products. For example, if a particular tenant is continuously growing storage and data stored by the tenant is compression friendly, the cloud provider can recommend that the tenant buy a compression license.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. In one embodiment, this cloud model includes at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. In one embodiment, there is a sense of location independence in that the consumer generally has no control or knowledge over the exact location of the provided resources but is able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. In one embodiment, it is managed by the organization or a third party and exists on-premises or off-premises.

Community cloud: the cloud infrastructure is shared by several organizations and supports a specific community that has shared concerns (e.g., mission, security requirements, policy, and compliance considerations). In one embodiment, it is managed by the organizations or a third party and exists on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure that includes a network of interconnected nodes.

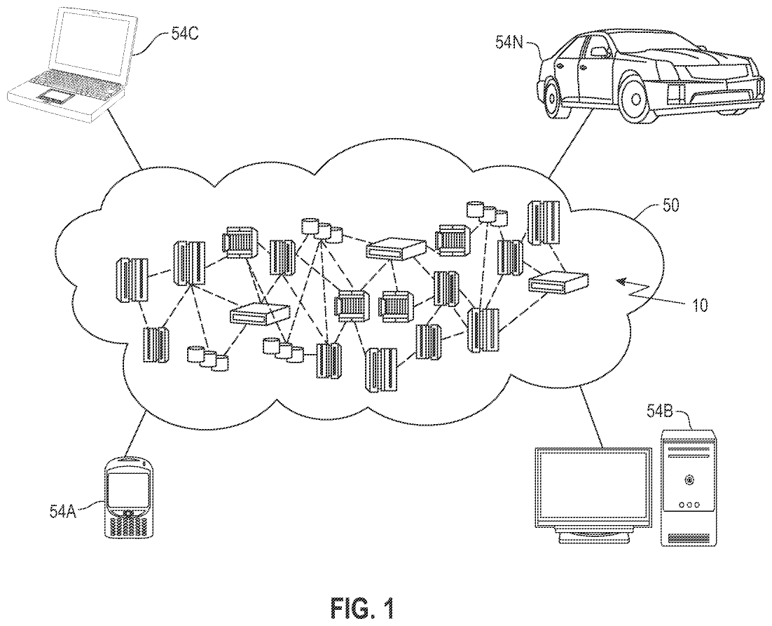

FIG. 1 depicts a cloud computing environment 50 according to an embodiment of the present invention. As shown, in one embodiment, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N communicate. In one embodiment, nodes 10 communicate with one another. In one embodiment, they are grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

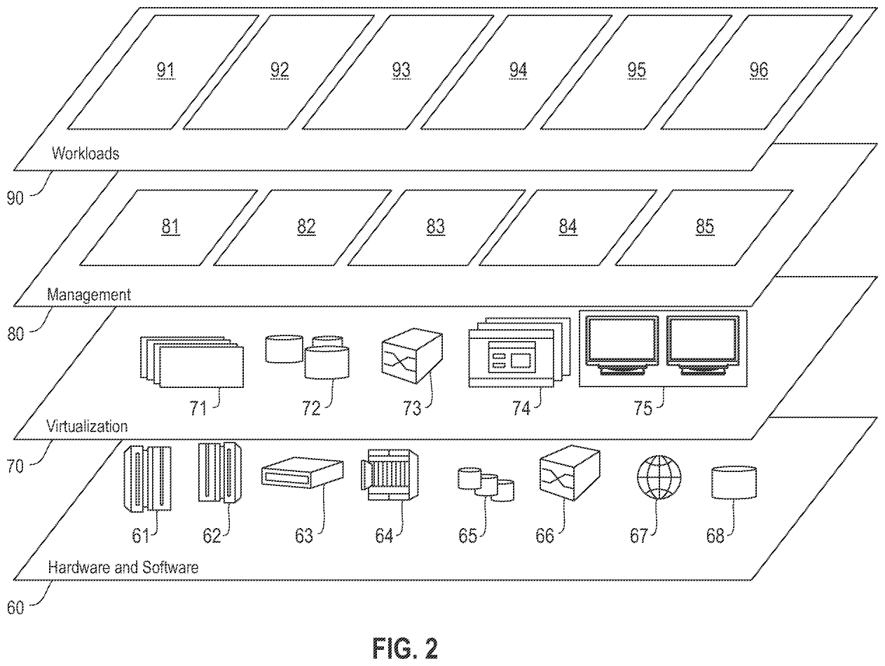

FIG. 2 depicts a set of functional abstraction layers provided by cloud computing environment 50 according to an embodiment of the present invention. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

In one embodiment, virtualization layer 70 provides an abstraction layer from which the following examples of virtual entities are provided: virtual servers 71; virtual storage 72; virtual networks 73, including virtual private networks; virtual applications and operating systems 74; and virtual clients 75.

In one embodiment, management layer 80 provides the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one embodiment, these resources include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

In one embodiment, workloads layer 90 provides examples of functionality for which the cloud computing environment is utilized. In one embodiment, examples of workloads and functions which are provided from this layer include: mapping and navigation 91; software development and lifecycle management 92; virtual classroom education delivery 93; data analytics processing 94; transaction processing 95; and cognitive allocation of monitoring resources 96 (e.g., a monitoring resources allocation system 200, as described in detail later herein).

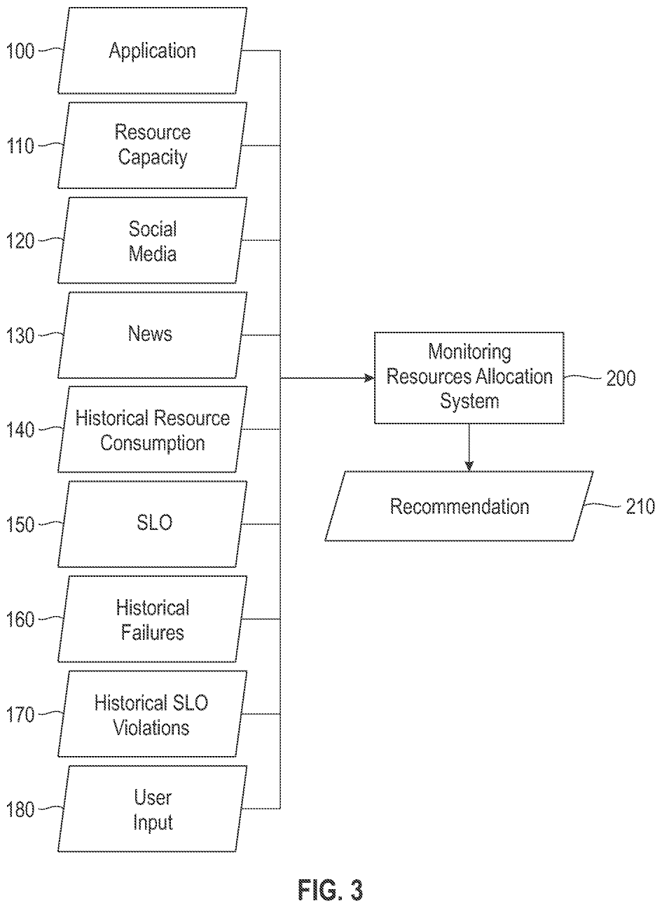

FIG. 3 illustrates an example monitoring resources allocation system 200, in one or more embodiments of the invention. The monitoring resources allocation system 200 is configured for cognitive allocation of monitoring resources for a plurality of applications. The plurality of applications represent a given set of cloud applications to be monitored. Each application of the plurality of applications is configured to execute/operate in a cloud computing environment (e.g., cloud computing environment 50 in FIG. 1). In one embodiment, the monitoring resources represent a limited amount/quantity of resources available for use in monitoring the plurality of applications.

In one embodiment, the monitoring resources allocation system 200 is configured to: (1) receive different types of input data relating to the plurality of applications and the cloud computing environment, and (2) determine a recommendation 210 based on the different types of input data, wherein the recommendation 210 comprises one or more recommended allocations of one or more monitoring resources available for use in monitoring the plurality of applications. In one embodiment, a recommendation 210 comprises a plurality of metrics to monitor and a corresponding frequency for each metric of the plurality of metrics (i.e., how often a metric should be monitored). In one embodiment, the monitoring resources allocation system 200 is configured to receive input data relating to each application of the plurality of applications.

In one embodiment, the monitoring resources allocation system 200 analyzes both structured data and unstructured data to provide a more accurate recommendation 210. In one embodiment, unstructured data comprises different types of raw data (e.g., unprocessed data, etc.) such as, but not limited to, one or more of the following: text, images, photos, videos, audio, etc. In one embodiment, structured data comprises different types of pre-processed data (e.g., annotated data, indexed data, etc.) such as, but not limited to, one or more of the following: text, images, photos, videos, audio, etc.

In one embodiment, the different types of input data that the monitoring resources allocation system 200 is configured to receive includes, but are not limited to, one or more of the following: (1) application data 100 relating to the plurality of applications, (2) resource capacity data 110 relating to one or more monitoring resources available for use in monitoring the plurality of applications, (3) social media data 120 comprising unstructured data relating to the plurality of applications and obtained from one or more social media data sources (e.g., Twitter, Instagram, Facebook, etc.), such as hashtags, mentions, social media pages, comments, etc., (4) news data 130 comprising unstructured data relating to the plurality of applications and obtained from one or more news data sources (e.g., news outlets such as CNN, NPR, AP, etc.), such as historical news information about at least one of the plurality of applications, historical news information about a deployment of a new application to be monitored, historical news information about a cloud provider of the cloud computing environment, etc., (5) historical resource consumption data 140 comprising structured data and unstructured data relating to historical workload resource consumption of each application of the plurality of applications (i.e., workload resource consumption over time) and types and timing of events that occurred in the past that are attributable to variations in the historical workload resource consumption (e.g., a high number of people streaming CNN during presidential debates, a low number of people streaming CNN between 1 am and 6 am EST), (6) service level objectives (SLO) data 150 relating to one or more SLOs relating to the plurality of applications, (7) historical failures data l60 comprising at least one of structured data and unstructured data relating to one or more failures that occurred in the past involving one or more of the plurality of applications, such as an insufficient memory error, an insufficient bandwidth error involving a streamed event, etc., (8) historical SLO violations data 170 comprising at least one of structured data and unstructured data relating to one or more violations of the one or more SLOs (i.e., SLO violations) that occurred in the past, and (9) user input data 180 comprising one or more constraints, such as user preferences, pre-defined parameters, pre-defined thresholds, etc.

In one embodiment, the application data 100 comprises at least one of structured data and unstructured data indicative of one or more attributes of one or more applications (i.e., application attributes) of the plurality of applications. Examples of different application attributes include, but are not limited to, a number of potential users for an application, average resource consumption per user of the application, industry field of a tenant deploying the application, geographical location of the tenant, company size of the tenant, etc.

In one embodiment, the SLO data 150 identifies one or more SLOs included in one or more service level agreements (SLA) between the cloud provider of the cloud computing environment and one or more tenants (i.e., clients) deploying the plurality of applications utilizing the cloud computing environment. A SLO represents one or more requirements that the cloud provider must fulfill to meet the needs of a tenant of the cloud computing environment, such as providing an adequate amount of memory, providing an adequate amount of bandwidth, etc. A SLO violation (e.g., insufficient memory, insufficient bandwidth, etc.) may result in the cloud provider having to pay a penalty to the tenant.

In one embodiment, structured data included in the historical failures data 160 comprises, but is not limited to, data indicative of a type, a number and/or a time stamp of each failure that occurred in the past involving the one or more plurality of applications. In one embodiment, unstructured data included in the historical failures data 160 comprises, but is not limited to, text data explaining each failure that occurred in the past involving the one or more plurality of applications.

In one embodiment, structured data included in the historical SLO violations data 170 comprises, but is not limited to, data indicative of a type, a number and/or a time stamp of each SLO violation that occurred in the past. In one embodiment, unstructured data included in the historical SLO violations data 170 comprises, but is not limited to, text data explaining each SLO violation that occurred in the past.

For expository purposes, the term “SLO-application pair” as used herein generally refers to a pair of the following: (1) a SLO violation relating to an application, wherein the SLO is included in a SLA between the cloud provider of the cloud computing environment and a tenant of the cloud computing environment whose workload includes executing/operating the application, and (2) application attributes relating to the application.

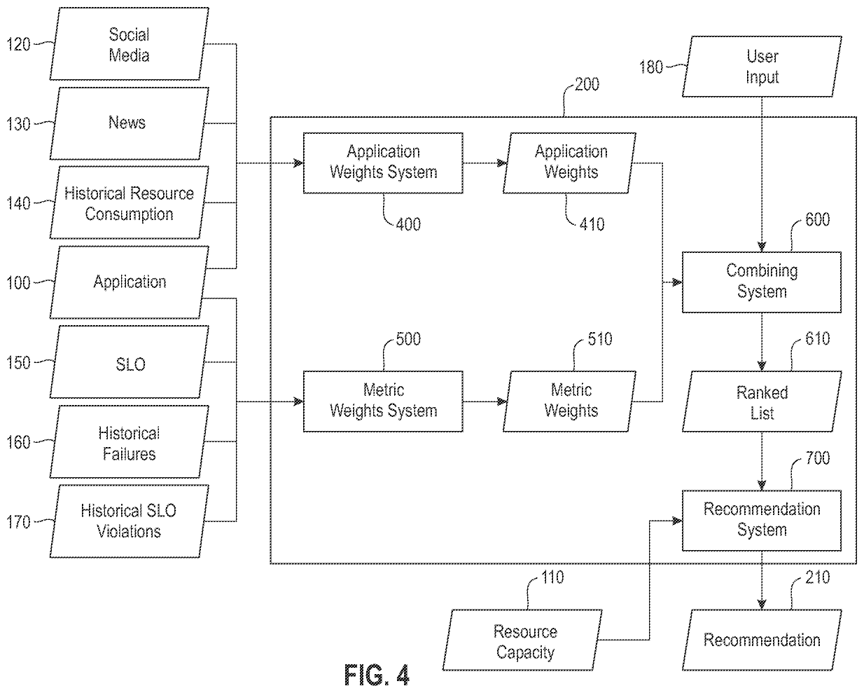

FIG. 4 illustrates an example monitoring resources allocation system 200, in one or more embodiments of the invention. In one embodiment, the monitoring resources allocation system 200 comprises an application weights system 400 configured to: (1) receive different types of input data relating to a plurality of applications to be monitored, (2) determine, for each application of the plurality of applications, a corresponding weight indicative of a predicted resource consumption of the application based on the different types of input data, and (3) generate application weights data 410 comprising each weight determined for each application of the plurality of applications. In one embodiment, the application weights data 410 is a weight vector comprising a plurality of weights, wherein each weight corresponds to an application of the plurality of applications.

In one embodiment, the different types of input data the application weights system 400 is configured to receive includes, but are not limited to, application data 100, social media data 120, news data 130, and historical resource consumption data 140.

Different embodiments of the application weights system 400 are described herein below.

In one embodiment, the monitoring resources allocation system 200 comprises a metric weights system 500 configured to: (1) receive different types of input data relating to the plurality of applications and a plurality of metrics to be monitored, (2) determine, for each metric of the plurality of metrics, a corresponding weight based on the different types of input data, and (3) generate metric weights data 510 comprising each weight determined for each metric of the plurality of metrics.

In one embodiment, the different types of input data the metric weights system 500 is configured to receive includes, but are not limited to, application data 100, SLO data 150, historical failures data 160, and historical SLO violations data 170.

Different embodiments of the metric weights system 500 are described herein below.

In one embodiment, the monitoring resources allocation system 200 comprises a combining system 600 configured to: (1) receive application weights data 410 from the application weights system 400, (2) receive metric weights data 510 from the metric weights system 500, (3) receive user input data 180, and (4) generate ranked list data 610 comprising a ranked list of a plurality metrics to monitor and a corresponding weight for each metric of the plurality of metrics based on the application weights data 410, the metric weights data 510, and the user input data 180. In one embodiment, the ranked list data 610 is indicative of an overall reward for monitoring the plurality of metrics, wherein the overall reward is based on a sum of each corresponding weight for each metric of the plurality of metrics.

In one embodiment, for each metric of the plurality of metrics, the combining system 600 is configured to combine a corresponding weight included in the application weights data 410 with a corresponding weight included in the metric weights data 510 by applying an aggregation function (e.g., average, median, some percentile, or any other function) to the corresponding weights to obtain one corresponding combined weight for the metric. The ranked list data 610 comprises, for each metric of the plurality of metrics, a corresponding combined weight for the metric.

In one embodiment, the monitoring resources allocation system 200 is configured to prioritize monitoring of critical/important applications to reduce occurrences of SLO violations (e.g., insufficient memory, insufficient bandwidth, etc.). This may result in increased savings for a cloud provider as it reduces or eliminates payment of penalties to tenants (i.e., clients) for SLO violations. Specifically, in one embodiment, user input data 180 received by the combining system 600 comprises application weight importance data indicative of a degree to which a user prioritizes weights for the plurality of applications over weights for the plurality of metrics. If user input data 180 received by the combining system 600 includes application weight importance data, the combining system 600 is configured to place more weight on the plurality of applications (i.e., increase weights for the plurality of applications) instead of placing more weight on the plurality of metrics. For example, in one embodiment, if the user input data 180 includes a value x representing a degree to which a user prioritizes weights for the plurality of applications over weights for the plurality of metrics, weights for the plurality of applications may be substantially about x-times more than weights for the plurality of metrics.

In one embodiment, the monitoring resources allocation system 200 comprises a recommendation system 700 configured to: (1) receive ranked list data 610 from the combining system 600, (2) receive resource capacity data 110 relating to one or more monitoring resources available for allocation, (3) determine one or more recommended allocations of the one or more monitoring resources for use in monitoring the plurality of applications based on the ranked list data 610 and the resource capacity data 110, and (4) output a recommendation 210 comprising the one or more recommended allocations.

In one embodiment, resource capacity data 110 received by the recommendation system 700 comprises available capacity of each monitoring resource available for use in monitoring the plurality of applications.

In one embodiment, the recommendation system 700 is configured to allocate the one or more monitoring resources to the plurality of metrics based on an optimization model that maximizes an overall reward for monitoring the plurality of metrics (e.g., sum of each corresponding weight for each metric of the plurality of metrics).

Let I denote a set of metrics, let R denote a set of monitoring resources available for use in monitoring a plurality of applications, let wᵢ denote a combined weight for a metric i∈I, and air denotes a required amount of a monitoring resource r E R in order to be able to monitor the metric i. Let capᵣ denote a total available capacity of resource r. Let Mᵢ denote a binary variable, wherein Mᵢ=1 if the metric i is to be monitored (e.g., included in the ranked list data 610), and Mᵢ=0 otherwise. In one embodiment, an optimal value Mᵢ is determined based on an integer programming mathematical optimization model that is represented in accordance with expressions (1) and (2) provided below:

$$\begin{matrix}Max {\sum }_{i ∈ I}^{ } {w}_{i} , {M}_{i} & ( 1 ) \\ s . t . {\sum }_{i ∈ I} {a}_{ir} , {M}_{i} \leq {cap}_{r} , ∀ r ∈ R & ( 2 )\end{matrix}$$

wherein expression (1) is an objective function that maximizes an overall reward for monitoring a plurality of metrics to be monitored, and expression (2) is a constraint that ensures available capacity of each monitoring resource is not exceeded.

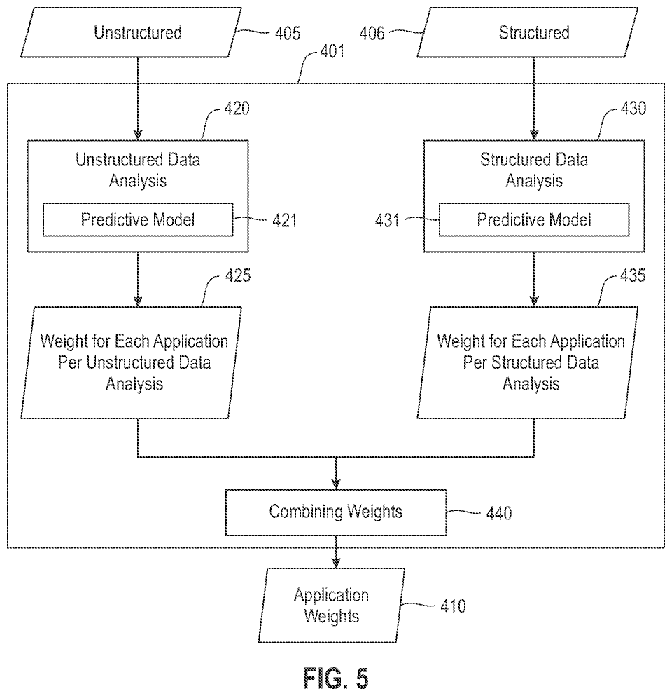

FIG. 5 illustrates an example workflow of a first example application weights system 401 configured to determine a weight for each application of a plurality of applications to be monitored by analyzing structured data and unstructured data separately, in one or more embodiments of the invention. In one embodiment, the application weights system 400 in FIG. 4 is implemented as the application weights system 401. In one embodiment, the application weights system 401 separately analyzes unstructured data and structured data relating to a plurality of applications to be monitored to determine, for each application of the plurality of applications, a corresponding weight indicative of a predicted resource consumption of the application. As described in detail later herein, the application weights system 401 utilizes at least two different predictive models trained to predict resource consumption (i.e., future resource consumption) of an application.

In one embodiment, the application weights system 401 comprises an unstructured data analysis unit 420 configured to: (1) receive unstructured data 405 comprising at least one of historical unstructured data relating to the plurality of applications (e.g., obtained from historical resource consumption data 140) and current unstructured data relating to the plurality of applications (e.g., obtained from social media data 120, news data 130), (2) perform unstructured data analysis on the unstructured data 405 utilizing a first trained predictive model (“first predictive model”) 421, and (3) generate a first set of weights 425 based on the unstructured data analysis. In one embodiment, the first set of weights 425 comprises, for each application of the plurality of applications, a corresponding weight indicative of a predicted resource consumption of the application. In one embodiment, the first set of weights 425 is a weight vector comprising a plurality of weights, wherein each weight corresponds to an application of the plurality of applications.

In one embodiment, unstructured data analysis performed by the unstructured data analysis unit 420 involves structuring the unstructured data 405 into structured data and applying the first predictive model 421 to the resulting structured data.

In one embodiment, unstructured data analysis performed by the unstructured data analysis unit 420 involves, but is not limited to, one or more of the following: text analytics (e.g., on text included in unstructured data), image or video processing (e.g., on photos, images and/or videos included in unstructured data), audio analytics (e.g., on audio included in unstructured data), etc. In one embodiment, the unstructured data analysis unit 420 is configured to apply one or more text analytics techniques such as, but not limited to, term frequency-inverse document frequency (tf-idf), bag-of-words, paragraph2vec, etc. In one embodiment, text analytics includes analyzing text into word/corpus, counting frequencies, and normalizing the frequencies (e.g., by dividing them by frequency of a word in the whole history). For example, in one embodiment, if there is a 1000 word corpus/dictionary, the unstructured data analysis unit 420 maintains a frequency vector that is 1000 positions wide, wherein each position corresponds to a word of the corpus/dictionary and maintains a frequency of the corresponding word. Each time the unstructured data analysis unit 420 encounters a particular word in the unstructured data 405, the unstructured data analysis unit 420 increases a frequency of the particular word in its corresponding position in the frequency vector. The unstructured data analysis unit 420 then applies TF-IDF to normalize the frequencies and obtain a weight vector comprising term frequencies relative to each data source.

In one embodiment, unstructured data analysis performed by the unstructured data analysis unit 420 comprises determining, for each application of the plurality of applications, a corresponding predicted resource consumption of the application. In one embodiment, each weight for each application included in the first set of weights 425 is based on a corresponding predicted resource consumption of the application. For example, in one embodiment, each weight for each application included in the first set of weights 425 is proportionally based (e.g., linearly or any other form) on a corresponding predicted resource consumption of the application.

In one embodiment, the unstructured data analysis unit 420 is configured to determine a corresponding predicted resource consumption of an application by determining a corresponding frequency of mentions of the application in the unstructured data 405. For example, in one embodiment, the unstructured data analysis unit 420 is configured to determine a frequency of mentions of an application in social media data 120 by determining frequencies of text relating to the application, such as hashtags, mentions, social media pages, comments, etc. As another example, the unstructured data analysis unit 420 is configured to determine a frequency of mentions of an application in news data 130 by determining frequencies of text relating to the application, such as mentions by news data sources.

In one embodiment, in a training phase, a first predictive model is trained to predict resource consumption of an application based on training data including historical unstructured data relating to the plurality of applications. In one embodiment, the training phase comprises structuring the historical unstructured data relating to the plurality of applications into structured data, and training the first predictive model on the resulting structured data. In one embodiment, different techniques are applied to train the first predictive model based on the training data such as, but not limited to, density-based techniques (e.g., k-nearest neighbor, local outlier factor, etc.), subspace and correlation-based outlier detection for high-dimensional data techniques, and one class support vector machines.

For example, in one embodiment, a first predictive model is trained based on features relating to workload resource consumption (e.g., features such as normalized frequencies resulting from text analytics, etc.). After training, the resulting first predictive model is deployed as a first predictive model 421 for use in a deployment phase to predict resource consumption of each application of the plurality of applications based on current unstructured data relating to the plurality of applications (i.e., unstructured data analysis).

In one embodiment, the application weights system 401 comprises a structured data analysis unit 430 configured to: (1) receive structured data 406 comprising at least one of historical structured data relating to the plurality of applications (e.g., obtained from historical resource consumption data 140) and current structured data relating to the plurality of applications, (2) perform structured data analysis on the structured data 405 utilizing a second trained predictive model (“second predictive model”) 431, and (3) generate a second set of weights 435 based on the structured data analysis. In one embodiment, the second set of weights 435 comprises, for each application of the plurality of applications, a corresponding weight indicative of a predicted resource consumption of the application. In one embodiment, the second set of weights 435 is a weight vector comprising a plurality of weights, wherein each weight corresponds to an application of the plurality of applications.

In one embodiment, structured data analysis performed by the structured data analysis unit 430 involves, but is not limited to, one or more of the following: text analytics (e.g., on text included in structured data), image or video processing (e.g., on photos, images and/or videos included in structured data), audio analytics (e.g., on audio included in structured data), etc.

In one embodiment, structured data analysis performed by the structured data analysis unit 430 comprises determining, for each application of the plurality of applications, a corresponding predicted resource consumption of the application. In one embodiment, each weight for each application included in the second set of weights 435 is based on a corresponding predicted resource consumption of the application. For example, in one embodiment, each weight for each application included in the second set of weights 435 is proportionally based (e.g., linearly or any other form) on a corresponding predicted resource consumption of the application.

In one embodiment, in a training phase, a second predictive model is trained to predict resource consumption of an application based on training data including historical structured data relating to the plurality of applications. In one embodiment, different techniques are applied to train the second predictive model based on the training data such as, but not limited to, density-based techniques (e.g., k-nearest neighbor, local outlier factor, etc.), subspace and correlation-based outlier detection for high-dimensional data techniques, and one class support vector machines.

For example, in one embodiment, a second predictive model is trained based on features relating to workload resource consumption (e.g., features such as normalized frequencies resulting from text analytics, etc.). After training, the resulting second predictive model is deployed as a second predictive model 431 for use in a deployment phase to predict resource consumption of each application of the plurality of applications based on current structured data relating to the plurality of applications (i.e., structured data analysis).

As another example, in one embodiment, a second predictive model is trained based on different application attributes of the plurality of applications such as, but not limited to, a number of potential users per application, average resource consumption per user per application, etc. The training results in a multi-variable regression model trained to receive application attributes as input features/variables. After training, the resulting multi-variable regression model is deployed as a second predictive model 431 for use in a deployment phase to predict resource consumption of each application of the plurality of applications based on current structured data relating to the plurality of applications (i.e., structured data analysis). In one embodiment, the multi-variable regression model is represented in accordance with equation (3) provided below:

y=α+x1β1+x2β2+ . . . +xmβm+ε (3),

wherein y is a continuous dependent/response variable representing resource consumption, and x₁, x₂, . . . , xₖ are predictors representing application attributes. In one embodiment, a separate multi-variable regression model is built for each type of data resource.

In one embodiment, the application weights system 401 is configured to perform unstructured data analysis and structured data analysis in parallel. In another embodiment, the application weights system 401 is configured to perform unstructured data analysis and structured data analysis sequentially, wherein the order of operations performed is configurable.

In one embodiment, the application weights system 401 comprises a combining weights unit 440 is configured to: (1) receive a first set of weights 425 from the unstructured data analysis unit 420, (2) receive a second set of weights 435 from the structured data analysis unit 430, and (3) combine weights included in the first set of weights 425 and the second set of weights 435 to generate application weights data 410 comprising, for each application of the plurality of applications, a corresponding weight for the application.

In one embodiment, for each application of the plurality of applications, the combining weights unit 440 combines a corresponding weight included in the first set of weights 425 with a corresponding weight included in the second set of weights 435 by applying an aggregation function (e.g., average, median, some percentile, or any other function) to the corresponding weights to obtain one corresponding combined weight for the application. The application weights data 410 comprises, for each application of the plurality of applications, a corresponding combined weight for the application obtained utilizing the aggregation function.

In another embodiment, for each application of the plurality of applications, the combining weights unit 440 combines a corresponding weight included in the first set of weights 425 with a corresponding weight included in the second set of weights 435 utilizing a third trained predictive model (“third predictive model”) to obtain one corresponding combined weight for the application. The application weights data 410 comprises, for each application of the plurality of applications, a corresponding combined weight for the application obtained utilizing the third predictive model.

In one embodiment, in a training phase, a third predictive model is trained to predict a combined weight for an application based on training data including: (1) a first weight for the application obtained utilizing a first predictive model trained based on historical unstructured data relating to the plurality of applications (e.g., first predictive model 421), and (2) a second weight for the application obtained utilizing a second predictive model trained based on historical structured data relating to the plurality of applications (e.g., second predictive model 431). In one embodiment, the training data further includes the historical structured data relating to the plurality of applications; in other embodiments, the inclusion of the historical structured data in the training data is optional. In one embodiment, different techniques are applied to train the third predictive model based on the training data such as, but not limited to, density-based techniques (e.g., k-nearest neighbor, local outlier factor, etc.), subspace and correlation-based outlier detection for high-dimensional data techniques, and one class support vector machines. After training, the resulting third predictive model is deployed as a third predictive model for use by the combining weights unit 440 in a deployment phase to predict a combined weight for each application of the plurality of applications based on a corresponding weight for the application included in the first set of weights 425, a corresponding weight for the application included in the second set of weights 435, and, optionally, current structured data relating to the plurality of applications.

Referring back to FIG. 4, in one embodiment, the combining system 600 is configured to receive application weights data 410 from the application weights system 401.

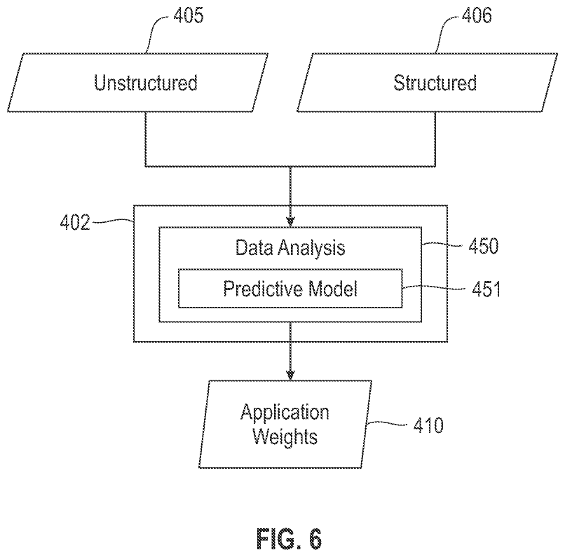

FIG. 6 illustrates an example workflow of a second example application weights system 402 configured to determine a weight for each application of a plurality of applications to be monitored by analyzing together structured data and unstructured data, in one or more embodiments of the invention. In one embodiment, the application weights system 400 in FIG. 4 is implemented as the application weights system 402. In one embodiment, the application weights system 402 analyzes together unstructured data and structured data relating to a plurality of applications to be monitored to determine, for each application of the plurality of applications, a corresponding weight indicative of a predicted resource consumption of the application. As described in detail later herein, the application weights system 402 utilizes one predictive model trained to predict resource consumption of an application.

In one embodiment, the application weights system 402 comprises a data analysis unit 450 configured to: (1) receive unstructured data 405 comprising at least one of historical unstructured data relating to the plurality of applications (e.g., obtained from historical resource consumption data 140) and current unstructured data relating to the plurality of applications (e.g., obtained from social media data 120, news data 130), (2) receive structured data 406 comprising at least one of historical structured data relating to the plurality of applications (e.g., obtained from historical resource consumption data 140) and current structured data relating to the plurality of applications, (3) perform data analysis on both the unstructured data 405 and the structured data 406 utilizing a trained predictive model 451, and (4) generate application weights data 410 based on the data analysis, wherein the application weights data 410 comprises, for each application of the plurality of applications, a corresponding weight indicative of a predicted resource consumption of the application.

In one embodiment, data analysis performed by the data analysis unit 450 involves structuring the unstructured data 405 into structured data and applying the same predictive model 451 to both the resulting structured data and the structured data 406.

In one embodiment, data analysis performed by the data analysis unit 450 involves, but is not limited to, one or more of the following: text analytics (e.g., on text included in structured data and unstructured data), image or video processing (e.g., on photos, images and/or videos included in structured data and unstructured data), audio analytics (e.g., on audio included in structured data and unstructured data), etc. For example, in one embodiment, text analytics includes, but is not limited to, analyzing text into word/corpus, counting frequencies, and normalizing the frequencies (e.g., by dividing them by frequency of a word in the whole history).

In one embodiment, in a training phase, a predictive model is trained to predict resource consumption of an application based on training data including both historical unstructured data and historical structured data relating to the plurality of applications. In one embodiment, the training phase comprises structuring the historical unstructured data relating to the plurality of applications into structured data, and training the predictive model on both the resulting structured data and the historical structured data relating to the plurality of applications. In one embodiment, different techniques are applied to train the predictive model based on the training data such as, but not limited to, density-based techniques (e.g., k-nearest neighbor, local outlier factor, etc.), subspace and correlation-based outlier detection for high-dimensional data techniques, and one class support vector machines.

For example, in one embodiment, a predictive model is trained based on features relating to workload resource consumption (e.g., features such as normalized frequencies resulting from text analytics, etc.). After training, the resulting predictive model is deployed as a predictive model 451 for use in a deployment phase to predict resource consumption of each application of the plurality of applications based on both current structured data and current unstructured data relating to the plurality of applications (i.e., data analysis).

As another example, in one embodiment, a predictive model is trained based on different application attributes of the plurality of applications such as, but not limited to, a number of potential users per application, average resource consumption per user per application, etc. The training results in a multi-variable regression model trained to receive application attributes as input features/variables. After training, the resulting multi-variable regression model is deployed as a predictive model 451 for use in a deployment phase to predict resource consumption of each application of the plurality of applications based on both current structured data and current unstructured data relating to the plurality of applications (i.e., data analysis). In one embodiment, the multi-variable regression model is represented in accordance with equation (3) provided above.

Unlike the application weights system 401 in FIG. 5 that utilizes at least two different predictive models (e.g., predictive models 421 and 431) to predict resource consumption of an application, the application weights system 402 utilizes only one predictive model (e.g., predictive model 451) to predict resource consumption of an application. Further, unlike the application weights system 401 in FIG. 5 where two different sets of weights (e.g., first set of weights 425 and second set of weights 435) are obtained as a result of utilizing the at least two different predictive models, only one set of weights (e.g., the application weights data 410) is obtained in the application weights system 402 as a result of utilizing only one predictive model. In one embodiment, compared to the application weights system 401, the application weights system 402 simplifies operations (e.g., removing the need to combine weights, analyze structured data and unstructured data separately, etc.) and reduces amount of resources required (e.g., memory, processing power, communication bandwidth, etc.).

Referring back to FIG. 4, in one embodiment, the combining system 600 is configured to receive application weights data 410 from the application weights system 402.

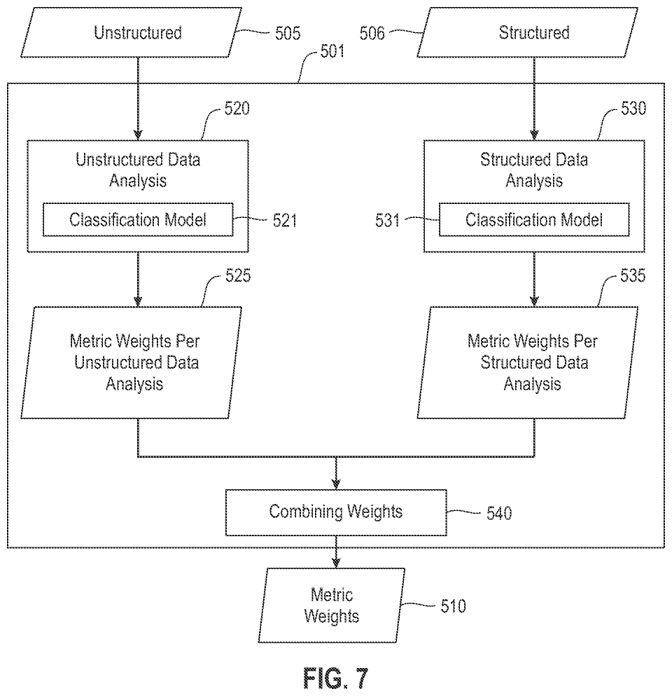

FIG. 7 illustrates an example workflow of a first example metric weights system 501 configured to determine a weight for each metric of a plurality of metrics to be monitored by analyzing structured data and unstructured data separately, in one or more embodiments of the invention. In one embodiment, the metric weights system 500 in FIG. 4 is implemented as the metric weights system 501. In one embodiment, the metric weights system 501 separately analyzes unstructured data and structured data relating to a plurality of applications to be monitored to determine, for each SLO-application pair, the following: (1) a corresponding set of metrics to be monitored for the SLO-application pair, and (2) for each metric of the corresponding set of metrics, a corresponding weight for the metric.

As described in detail later herein, the metric weights system 501 utilizes at least two different machine learning classifiers (i.e., classification models) in classifying a failure involving an application with a classification indicative of whether the failure is associated with a SLO violation relating to the application.

In one embodiment, the metric weights system 501 comprises an unstructured data analysis unit 520 configured to: (1) receive unstructured data 505 comprising at least one of historical unstructured data relating to the plurality of applications (e.g., obtained from historical failures data 160, historical SLO violations data 170) and current unstructured data relating to the plurality of applications (e.g., obtained from application data 100, SLO data 150), (2) perform unstructured data analysis on the unstructured data 505 utilizing a first trained classification model (“first classification model”) 521, and (3) generate a first metric weights data 525 based on the unstructured data analysis. In one embodiment, the first metric weights data 525 comprises, for each SLO-application pair, the following: (1) a corresponding set of metrics to be monitored for the SLO-application pair, and (2) for each metric of the corresponding set of metrics, a corresponding weight for the metric.

In one embodiment, unstructured data analysis performed by the unstructured data analysis unit 520 involves structuring the unstructured data 505 into structured data and applying the first classification model 521 to the resulting structured data.

In one embodiment, unstructured data analysis performed by the unstructured data analysis unit 520 involves, but is not limited to, one or more of the following: text analytics (e.g., on text included in unstructured data), image or video processing (e.g., on photos, images and/or videos included in unstructured data), audio analytics (e.g., on audio included in unstructured data), etc. In one embodiment, the unstructured data analysis unit 520 is configured to apply one or more text analytics techniques such as, but not limited to, term frequency-inverse document frequency (tf-idf), bag-of-words, paragraph2vec, etc. In one embodiment, text analytics includes analyzing text into word/corpus, counting frequencies, and normalizing the frequencies (e.g., by dividing them by frequency of a word in the whole history).

In one embodiment, in a training phase, a first machine learning classifier is trained to predict/output a score indicative of a likelihood/probability that a failure is associated with a SLO violation based on training data including historical unstructured data relating to the plurality of applications. For example, in one embodiment, the first machine learning classifier is trained to predict/output a number between 0 and 1 for the failure, wherein the number is used to classify the failure with a classification indicative of whether the failure is associated with the SLO violation. In one embodiment, the training phase comprises structuring the historical unstructured data relating to the plurality of applications into structured data, and training the first machine learning classifier on the resulting structured data. In one embodiment, different techniques are applied to train the first machine learning classifier based on the training data such as, but not limited to, density-based techniques (e.g., k-nearest neighbor, local outlier factor, etc.), subspace and correlation-based outlier detection for high-dimensional data techniques, and one class support vector machines.

For example, in one embodiment, a first machine learning classifier is trained based on features relating to workload resource consumption (e.g., features such as normalized frequencies resulting from text analytics, etc.). After training, the first resulting machine learning classifier is deployed as a first classification model 521 for use in a deployment phase to classify each failure involving each application of the plurality of applications with a classification indicative of whether the failure is associated with a SLO violation relating to the application based on current unstructured data relating to the plurality of applications (i.e., unstructured data analysis).

In one embodiment, in the deployment phase, the first classification model 521 is configured to: (1) receive, as input, a SLO violation relating to an application and application attributes relating to the application (i.e., a SLO-application pair), and (2) predict/output a score (e.g., a number between 0 and 1) for a failure involving the application, wherein the failure is classified with a classification indicative of whether the failure is associated with the SLO violation based on the score. For example, in one embodiment, the failure is classified with one of the following: (1) a first classification (e.g., 1) indicative that the failure is associated with the SLO violation if the score is equal to or greater than a pre-defined threshold (e.g., 0.5), or (2) a second classification (e.g., 0) indicative that the failure is not associated with the SLO violation if the score is less than the pre-defined threshold.

In one embodiment, a higher a score predicted/outputted by the first classification model 521 for a failure involving an application, a higher an amount of impact the failure has on a SLO violation relating to the application. For each SLO-application pair, the unstructured data analysis unit 520 is configured to: (1) collect each failure classified with a classification (e.g., 1) indicative that the failure is associated with a SLO violation of the pair, (2) rank impact of all failures collected on the SLO violation based on scores outputted/predicted by the first classification model 521 for the failures, and (3) based on a resulting ranking, determine a corresponding set of metrics to be monitored for the SLO-application pair and a corresponding weight for each metric of the corresponding set of metrics. The first metric weights data 525 generated by the unstructured data analysis unit 520 includes each set of metrics determined and each weight determined for each metric of the set of metrics.

In one embodiment, the metric weights system 501 comprises a structured data analysis unit 530 configured to: (1) receive structured data 506 comprising at least one of historical structured data relating to the plurality of applications (e.g., obtained from historical failures data 160, historical SLO violations data 170) and current structured data relating to the plurality of applications (e.g., obtained from application data 100, SLO data 150), (2) perform structured data analysis on the structured data 506 utilizing a second trained classification model (“second classification model”) 531, and (3) generate a second metric weights data 535 based on the structured data analysis. In one embodiment, the second metric weights data 535 comprises, for each SLO-application pair, the following: (1) a corresponding set of metrics to be monitored for the SLO-application pair, and (2) for each metric of the corresponding set of metrics, a corresponding weight for the metric.

In one embodiment, structured data analysis performed by the structured data analysis unit 530 involves, but is not limited to, one or more of the following: text analytics (e.g., on text included in structured data), image or video processing (e.g., on photos, images and/or videos included in structured data), audio analytics (e.g., on audio included in structured data), etc.

In one embodiment, in a training phase, a second machine learning classifier is trained to predict/output a score indicative of a likelihood/probability that a failure is associated with a SLO violation based on training data including historical structured data relating to the plurality of applications. For example, in one embodiment, the second machine learning classifier is trained to predict/output a number between 0 and 1 for the failure, wherein the number is used to classify the failure with a classification indicative of whether the failure is associated with the SLO violation. In one embodiment, different techniques are applied to train the second machine learning classifier based on the training data such as, but not limited to, density-based techniques (e.g., k-nearest neighbor, local outlier factor, etc.), subspace and correlation-based outlier detection for high-dimensional data techniques, and one class support vector machines.

For example, in one embodiment, a second machine learning classifier is trained based on features relating to workload resource consumption (e.g., features such as normalized frequencies resulting from text analytics, etc.). After training, the resulting second machine learning classifier is deployed as a second classification model 531 for use in a deployment phase to classify each failure involving each application of the plurality of applications with a classification indicative of whether the failure is associated with a SLO violation relating to the application based on current structured data relating to the plurality of applications (i.e., structured data analysis).

As another example, in one embodiment, a second machine learning classifier is trained based on different types of SLO violations and different application attributes relating to the plurality of applications (e.g., a number of potential users per application, average resource consumption per user per application, etc.). After training, the resulting second machine learning classifier is deployed as a second classification model 531 for use in a deployment phase to classify each failure involving each application of the plurality of applications with a classification indicative of whether the failure is associated with a SLO violation relating to the application based on current structured data relating to the plurality of applications (i.e., structured data analysis).

In one embodiment, in the deployment phase, the second classification model 531 is configured to: (1) receive, as input, a SLO violation relating to an application and application attributes relating to the application (i.e., a SLO-application pair), (2) predict/output a score (e.g., a number between 0 and 1) for a failure involving the application, wherein the failure is classified with a classification indicative of whether the failure is associated with the SLO violation based on the score. For example, in one embodiment, the failure is classified with one of the following: (1) a first classification (e.g., 1) indicative that the failure is associated with the SLO violation if the score is equal to or greater than a pre-defined threshold (e.g., 0.5), or (2) a second classification (e.g., 0) indicative that the failure is not associated with the SLO violation if the score is less than the pre-defined threshold.

In one embodiment, a higher a score predicted/outputted by the second classification model 531 for a failure involving an application, a higher an amount of impact the failure has on a SLO violation relating to the application. For each SLO-application pair, the structured data analysis unit 530 is configured to: (1) collect each failure classified with a classification (e.g., 1) indicative that the failure is associated with a SLO violation of the pair, (2) rank impact of all failures collected on the SLO violation based on scores outputted/predicted by the second classification model 531 for the failures, and (3) based on a resulting ranking, determine a corresponding set of metrics to be monitored for the SLO-application pair and a corresponding weight for each metric of the corresponding set of metrics. The second metric weights data 535 generated by the structured data analysis unit 530 includes each set of metrics determined and each weight determined for each metric of the set of metrics.

In one embodiment, the metric weights system 501 is configured to perform unstructured data analysis and structured data analysis in parallel. In another embodiment, the metric weights system 501 is configured to perform unstructured data analysis and structured data analysis sequentially, wherein the order of operations performed is configurable.

In one embodiment, the metric weights system 501 comprises a combining weights unit 540 is configured to: (1) receive a first metric weights data 525 from the unstructured data analysis unit 520, (2) receive a second metric weights data 535 from the structured data analysis unit 530, and (3) combine weights included in the first metric weights data 525 and the second metric weights data 535 to generate metric weights data 510 comprising, for each SLO-application pair, the following: (1) a corresponding set of metrics to be monitored for the SLO-application pair, and (2) for each metric of the corresponding set of metrics, a corresponding weight for the metric.

In one embodiment, for each SLO-application pair, the combining weights unit 540 combines a corresponding set of metrics and weights included in the first metric weights data 525 with a corresponding set of metrics and weights included in the second metric weights data 535 by applying an aggregation function (e.g., average, median, some percentile, or any other function) to the corresponding sets of metrics and weights to obtain one corresponding combined set of metrics and weights for the SLO-application pair. The metric weights data 510 comprises, for each SLO-application pair, the following: (1) a corresponding combined set of metrics to be monitored for the SLO application pair obtained utilizing the aggregation function, and (2) for each metric of the corresponding combined set of metrics, a corresponding weight for the metric obtained utilizing the aggregation function.

In another embodiment, for each SLO-application pair, the combining weights unit 540 combines a corresponding set of metrics and weights included in the first metric weights data 525 with a corresponding set of metrics and weights included in the second metric weights data 535 utilizing a trained predictive model to obtain one corresponding combined set of metrics and weights for the SLO-application pair. The metric weights data 510 comprises, for each SLO-application pair, the following: (1) a corresponding combined set of metrics to be monitored for the SLO application pair obtained utilizing the predictive model, and (2) for each metric of the corresponding combined set of metrics, a corresponding weight for the metric obtained utilizing the predictive model.

In one embodiment, in a training phase, a predictive model is trained to predict a corresponding combined set of metrics and weights for an SLO-application pair based on training data including: (1) a first set of metrics and weights for the SLO-application pair obtained utilizing a first classification model trained based on historical unstructured data relating to the plurality of applications (e.g., first classification model 521), and (2) a second set of metrics and weights for the SLO-application pair obtained utilizing a second classification model trained based on historical structured data relating to the plurality of applications (e.g., second classification model 531). In one embodiment, the training data further includes the historical structured data relating to the plurality of applications; in other embodiments, the inclusion of the historical structured data in the training data is optional. In one embodiment, different techniques are applied to train the predictive model based on the training data such as, but not limited to, density-based techniques (e.g., k-nearest neighbor, local outlier factor, etc.), subspace and correlation-based outlier detection for high-dimensional data techniques, and one class support vector machines. After training, the resulting predictive model is deployed as a predictive model for use by the combining weights unit 540 in a deployment phase to predict a combined set of metrics and weights for each SLO-application pair based on a corresponding set of metrics and weights included in the first metric weights data 525, a corresponding set of metrics and weights included in the second metric weights data 535, and, optionally, current structured data relating to the plurality of applications.

Referring back to FIG. 4, in one embodiment, the combining system 600 is configured to receive metric weights data 510 from the metric weights system 501.

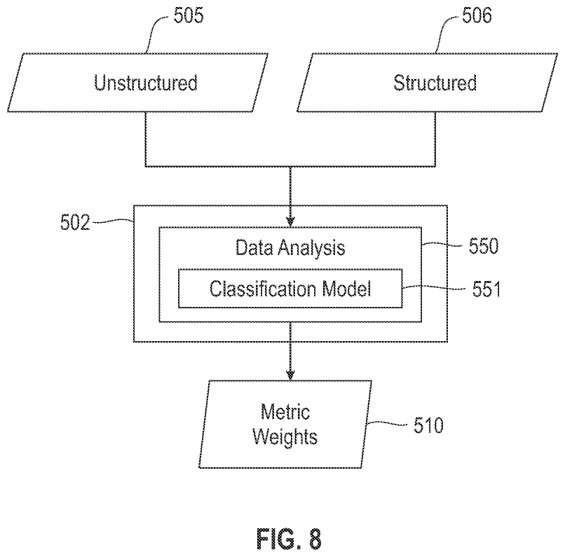

FIG. 8 illustrates an example workflow of a second example metric weights system 502 configured to determine a weight for each metric of a plurality of metrics to be monitored by analyzing together structured data and unstructured data, in one or more embodiments of the invention. In one embodiment, the metric weights system 500 in FIG. 4 is implemented as the metric weights system 502. In one embodiment, the metric weights system 502 analyzes together unstructured data and structured data relating to a plurality of applications to be monitored to determine, for each SLO-application pair, the following: (1) a corresponding set of metrics to be monitored for the SLO-application pair, and (2) for each metric of the corresponding set of metrics, a corresponding weight for the metric.

As described in detail later herein, the metric weights system 502 utilizes one machine learning classifier in classifying a failure involving an application with a classification indicative of whether the failure is associated with a SLO violation relating to the application.

In one embodiment, the metric weights system 502 comprises a data analysis unit 550 configured to: (1) receive unstructured data 505 comprising at least one of historical unstructured data relating to the plurality of applications (e.g., obtained from historical failures data 160, historical SLO violations data 170) and current unstructured data relating to the plurality of applications (e.g., obtained from application data 100, SLO data 150), (2) receive structured data 506 comprising at least one of historical structured data relating to the plurality of applications (e.g., obtained from historical failures data 160, historical SLO violations data 170) and current structured data relating to the plurality of applications (e.g., obtained from application data 100, SLO data 150), (3) perform data analysis on both the unstructured data 505 and the structured data 506 utilizing a trained classification model 551, and (4) generate metric weights data 510 based on the data analysis. In one embodiment, the metric weights data 510 comprises, for each SLO-application pair, the following: (1) a corresponding set of metrics to be monitored for the SLO-application pair, and (2) for each metric of the corresponding set of metrics, a corresponding weight for the metric.

In one embodiment, data analysis performed by the data analysis unit 550 involves structuring the unstructured data 505 into structured data and applying the same classification model 551 to both the resulting structured data and the structured data 506.

In one embodiment, data analysis performed by the data analysis unit 550 involves, but is not limited to, one or more of the following: text analytics (e.g., on text included in structured data and unstructured data), image or video processing (e.g., on photos, images and/or videos included in structured data and unstructured data), audio analytics (e.g., on audio included in structured data and unstructured data), etc. For example, text analytics includes, but is not limited to, analyzing text into word/corpus, counting frequencies, and normalizing the frequencies (e.g., by dividing them by frequency of a word in the whole history).

In one embodiment, in a training phase, a machine learning classifier is trained to predict/output a score indicative of a likelihood/probability that a failure is associated with a SLO violation based on training data including both historical unstructured data and historical structured data relating to the plurality of applications. For example, in one embodiment, the machine learning classifier is trained to predict/output a number between 0 and 1 for the failure, wherein the number is used to classify the failure with a classification indicative of whether the failure is associated with the SLO violation. In one embodiment, the training phase comprises structuring the historical unstructured data relating to the plurality of applications into structured data, and training the machine learning classifier on both the resulting structured data and the historical structured data relating to the plurality of applications. In one embodiment, different techniques are applied to train the machine learning classifier based on the training data such as, but not limited to, density-based techniques (e.g., k-nearest neighbor, local outlier factor, etc.), subspace and correlation-based outlier detection for high-dimensional data techniques, and one class support vector machines.

For example, in one embodiment, the machine learning classifier is trained based on features relating to workload resource consumption (e.g., features such as normalized frequencies resulting from text analytics, etc.). After training, the resulting machine learning classifier is deployed as a classification model 551 for use in a deployment phase to classify each failure involving each application of the plurality of applications with a classification indicative of whether the failure is associated with a SLO violation relating to the application based on both current structured data and current unstructured data relating to the plurality of applications (i.e., data analysis).

In one embodiment, in the deployment phase, the classification model 551 is configured to: (1) receive, as input, a SLO violation relating to an application and application attributes relating to the application (i.e., a SLO-application pair), and (2) predict/output a score (e.g., a number between 0 and 1) for a failure involving the application, wherein the failure is classified with a classification indicative of whether the failure is associated with the SLO violation based on the score. For example, in one embodiment, the failure is classified with one of the following: (1) a first classification (e.g., 1) indicative that the failure is associated with the SLO violation if the score is equal to or greater than a pre-defined threshold (e.g., 0.5), or (2) a second classification (e.g., 0) indicative that the failure is not associated with the SLO violation if the score is less than the pre-defined threshold.

In one embodiment, a higher a score predicted/outputted by the classification model 551 for a failure involving an application, a higher an amount of impact the failure has on a SLO violation relating to the application. For each SLO-application pair, the data analysis unit 550 is configured to: (1) collect each failure classified with a classification (e.g., 1) indicative that the failure is associated with a SLO violation of the pair, (2) rank impact of all failures collected on the SLO violation based on scores outputted/predicted by the classification model 551 for the failures, and (2) based on a resulting ranking, determine a corresponding set of metrics to be monitored for the SLO-application pair and a corresponding weight for each metric of the corresponding set of metrics. The metric weights data 510 generated by the data analysis unit 550 includes each set of metrics determined and each weight determined for each metric of the set of metrics.

Unlike the metric weights system 501 in FIG. 7 that utilizes at least two different classification models (e.g., classification models 521 and 531), the metric weights system 502 utilizes only one classification model (e.g., classification model 551). Further, unlike the metric weights system 501 in FIG. 7 where two different sets of weights (e.g., first metric weights data 525 and second metric weights data 535) are obtained as a result of utilizing the at least two different classification models, only one set of weights (e.g., the metric weights data 510) is obtained in the metric weights system 502 as a result of utilizing only one classification model. In one embodiment, compared to the metric weights system 501, the metric weights system 502 simplifies operations (e.g., removing the need to combine weights, analyze structured data and unstructured data separately, etc.) and reduces amount of resources required (e.g., memory, processing power, communication bandwidth, etc.).

Referring back to FIG. 4, in one embodiment, the combining system 600 is configured to receive metric weights data 510 from the metric weights system 502.

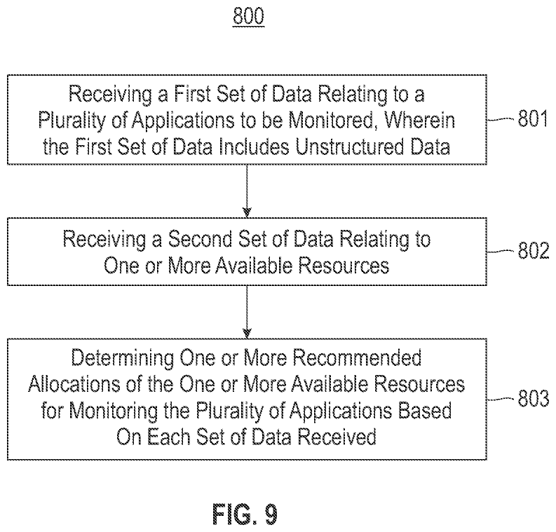

FIG. 9 is a flowchart of an example process 800 for cognitive allocation of monitoring resources for a plurality of applications, in one or more embodiments of the invention. Process block 801 includes receiving a first set of data relating to a plurality of applications to be monitored, wherein the first set of data includes unstructured data. Process block 802 includes receiving a second set of data relating to one or more available resources. Process block 803 includes determining one or more recommended allocations of the one or more available resources for monitoring the plurality of applications based on each set of data received.

In one embodiment, process blocks 801-803 is performed by one or more components of the monitoring resources allocation system 200 in FIGS. 3-4, such as the first example application weights system 401 in FIG. 5, the second example application weights system 402 in FIG. 6, the first example metric weights system 501 in FIG. 7, and/or the second example metric weights system 502 in FIG. 8.

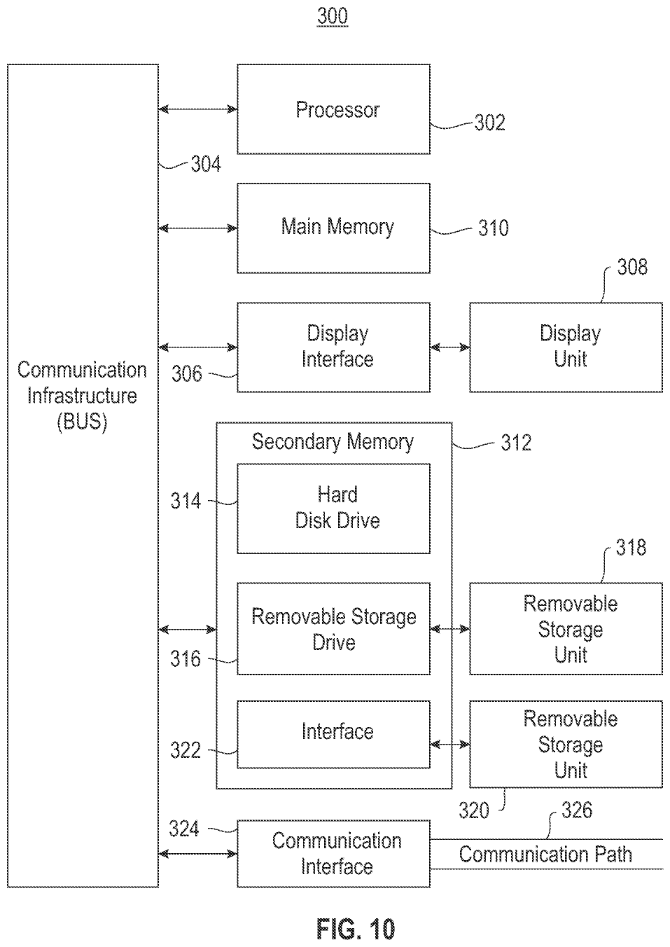

FIG. 10 is a high level block diagram showing an information processing system 300 useful for implementing one embodiment of the invention. The computer system includes one or more processors, such as processor 302. The processor 302 is connected to a communication infrastructure 304 (e.g., a communications bus, cross-over bar, or network).

The computer system can include a display interface 306 that forwards graphics, text, and other data from the voice communication infrastructure 304 (or from a frame buffer not shown) for display on a display unit 308. In one embodiment, the computer system also includes a main memory 310, preferably random access memory (RAM), and also includes a secondary memory 312. In one embodiment, the secondary memory 312 includes, for example, a hard disk drive 314 and/or a removable storage drive 316, representing, for example, a floppy disk drive, a magnetic tape drive, or an optical disk drive. The removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc. which is read by and written to by removable storage drive 316. As will be appreciated, the removable storage unit 318 includes a computer readable medium having stored therein computer software and/or data.

In alternative embodiments, the secondary memory 312 includes other similar means for allowing computer programs or other instructions to be loaded into the computer system. Such means include, for example, a removable storage unit 320 and an interface 322. Examples of such means include a program package and package interface (such as that found in video game devices), a removable memory chip (such as an EPROM, or PROM) and associated socket, and other removable storage units 320 and interfaces 322, which allows software and data to be transferred from the removable storage unit 320 to the computer system.

In one embodiment, the computer system also includes a communication interface 324. Communication interface 324 allows software and data to be transferred between the computer system and external devices. In one embodiment, examples of communication interface 324 include a modem, a network interface (such as an Ethernet card), a communication port, or a PCMCIA slot and card, etc. In one embodiment, software and data transferred via communication interface 324 are in the form of signals which are, for example, electronic, electromagnetic, optical, or other signals capable of being received by communication interface 324. These signals are provided to communication interface 324 via a communication path (i.e., channel) 326. In one embodiment, this communication path 326 carries signals and is implemented using wire or cable, fiber optics, a phone line, a cellular phone link, an RF link, and/or other communication channels.

Embodiments of the present invention provide a system, a method, and/or a computer program product. In one embodiment, the computer program product includes a computer readable storage medium (or media) having computer readable program instructions thereon for causing a processor to carry out aspects of the present invention. The computer readable storage medium can be a tangible device that can retain and store instructions for use by an instruction execution device. In one embodiment, the computer readable storage medium is, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. In one embodiment, the network comprises copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In one embodiment, computer readable program instructions for carrying out operations of embodiments of the present invention are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In one embodiment, the computer readable program instructions execute entirely on the user's computer, partly on the user's computer, as a stand-alone software package, partly on the user's computer and partly on a remote computer or entirely on the remote computer or server. In the latter scenario, in one embodiment, the remote computer is connected to the user's computer through any type of network, including a local area network (LAN) or a wide area network (WAN), or the connection is made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

In one embodiment, these computer readable program instructions are provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In one embodiment, these computer readable program instructions are also stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In one embodiment, the computer readable program instructions are also loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, in one embodiment, each block in the flowchart or block diagrams represents a module, segment, or portion of instructions, which comprises one or more executable instructions for implementing the specified logical function(s). In some alternative implementations, the functions noted in the block occur out of the order noted in the figures. For example, in one embodiment, two blocks shown in succession are, in fact, executed substantially concurrently, or the blocks are sometimes executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

From the above description, it can be seen that embodiments of the present invention provide a system, computer program product, and method for implementing the embodiments of the invention. Embodiments of the present invention further provide a non-transitory computer-useable storage medium for implementing the embodiments of the invention. The non-transitory computer-useable storage medium has a computer-readable program, wherein the program upon being processed on a computer causes the computer to implement the steps of embodiments of the present invention described herein. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. Various embodiments of the invention were chosen and described in order to best explain the principles of the embodiments of the invention and the practical application, and to enable others of ordinary skill in the art to understand the embodiments of the invention with various modifications as are suited to the particular use contemplated.

What is claimed is:

1. A method comprising:
receiving a first set of data relating to a plurality of applications to be monitored, wherein the first set of data includes unstructured data;
receiving a second set of data relating to one or more available resources; and
determining one or more recommended allocations of the one or more available resources for monitoring the plurality of applications based on each set of data received.

2. The method of claim 1, wherein the first set of data comprises one or more of the following: application data comprising one or more application attributes of the plurality of applications, social media data comprising unstructured data obtained from one or more social media data sources, news data comprising unstructured data obtained from one or more news media data sources, historical resource consumption data comprising structured data and unstructured data relating to historical workload resource consumption of the plurality of applications, service level objectives (SLO) data comprising one or more SLOs relating to the plurality of applications, historical failures data comprising at least one of structured data and unstructured data relating to one or more failures that occurred in the past involving the plurality of applications, historical SLO violations data comprising at least one of structured data and unstructured data relating to one or more violations of the one or more SLOs that occurred in the past, and user input data indicative of a degree to which a user prioritizes monitoring the plurality of applications over monitoring metrics.

3. The method of claim 2, wherein the second set of data is indicative of available capacity of each available resource of the one or more available resources.

4. The method of claim 3, where determining one or more recommended allocations of the one or more available resources for monitoring the plurality of applications based on each set of data received comprises:
determining a set of application weights by determining, for each application of the plurality of applications, a corresponding weight for the application based on the first set of data, wherein the set of application weights includes each weight determined for each application of the plurality of applications; and
determining a set of metric weights by determining a plurality of metrics to monitor and a corresponding weight for each metric of the plurality of metrics based on the first set of data, wherein the set of metric weights includes each weight determined for each metric of the plurality of metrics.

5. The method of claim 4, wherein determining a set of application weights further comprises:
analyzing unstructured data and structured data included in the first set of data separately by:
applying a first predictive model to the unstructured data;
applying a second predictive model to the structured data;
obtaining a first set of weights from the first predictive model;
obtaining a second set of weights from the second predictive model; and
combining the first set of weights and the second set of weights to obtain the set of application weights;
wherein each of the first predictive model and the second predictive model is trained to predict a resource consumption of an application, and a weight for the application is determined based on the resource consumption predicted.

6. The method of claim 5, wherein applying a first predictive model to the unstructured data comprises:
determining, for each application of the plurality of applications, a corresponding frequency of mentions of the application in the unstructured data, wherein a corresponding resource consumption of the application is predicted based on the corresponding frequency of mentions determined.

7. The method of claim 5, wherein the second predictive model is a regression model trained to predict resource consumption of an application based on application attributes of the application.

8. The method of claim 5, wherein combining the first set of weights and the second set of weights to obtain the set of application weights comprises:
combining the first set of weights and the second set of weights based on at least one of an aggregation function and a third predictive model.

9. The method of claim 4, wherein determining a set of application weights further comprises:
analyzing together unstructured data and structured data included in the first set of data by applying a predictive model to both the unstructured data and the structured data; and
obtaining a set of weights from the predictive model, wherein the set of application weights is the set of weights;
wherein the predictive model is trained to predict a resource consumption of an application, and a weight for the application is determined based on the resource consumption predicted.

10. The method of claim 9, wherein applying a predictive model to both the unstructured data and the structured data comprises:
structuring the unstructured data into new structured data; and
applying the predictive model to both the new structured data and the structured data.

11. The method of claim 9, wherein the predictive model is a regression model trained to predict resource consumption of an application based on application attributes of the application.

12. The method of claim 4, wherein determining a set of metric weights further comprises:
analyzing unstructured data and structured data included in the first set of data separately by:
applying a first classification model to the unstructured data;
applying a second classification model to the structured data;
obtaining a first set of weights based on scores from the first classification model;
obtaining a second set of weights based on scores from the second classification model; and
combining the first set of weights and the second set of weights to obtain the set of metric weights;
wherein each classification model is trained to predict a score indicative of a likelihood that a failure involving an application is associated with a SLO violation relating to the application;
wherein the first classification model is trained based on historical unstructured data relating to one or more applications; and
wherein the second classification model is trained based on historical structured data relating to one or more applications.

13. The method of claim 12, wherein combining the first set of weights and the second set of weights to obtain the set of metric weights comprises:
combining the first set of weights and the second set of weights based on at least one of an aggregation function and a predictive model.

14. The method of claim 4, wherein determining a set of metric weights further comprises:
analyzing together unstructured data and structured data included in the first set of data by applying a classification model to both the unstructured data and the structured data; and
obtaining a set of weights based on scores from the classification model, wherein the set of metric weights is the set of weights;
wherein the classification model is trained to predict a score indicative of a likelihood that a failure involving an application is associated with a SLO violation relating to the application; and
wherein the classification model is trained based on historical unstructured data relating to one or more applications and historical structured data relating to the one or more applications.

15. The method of claim 14, wherein applying a classification model to both the unstructured data and the structured data comprises:
structuring the unstructured data into new structured data; and
applying the classification model to both the new structured data and the structured data.

16. The method of claim 4, wherein determining one or more recommended allocations of the one or more available resources for monitoring the plurality of applications based on each set of data received further comprises:
determining a ranked link of metrics to monitor based on the set of application weights, the set of metric weights, and the user input data; and
determining the one or more recommended allocations based on the ranked list, the second set of data, and an optimization model.

17. The method of claim 16, wherein determining a ranked link of metrics to monitor based on the set of application weights, the set of metric weights, and the user input data comprises:
combining the set of application weights and the set of metric weights based on an aggregation function.

18. The method of claim 16, wherein the optimization model is an integer programming model.

19. A system comprising:
at least one processor; and
a non-transitory processor-readable memory device storing instructions that when executed by the at least one processor causes the at least one processor to perform operations including:
receiving a first set of data relating to a plurality of applications to be monitored, wherein the first set of data includes unstructured data;
receiving a second set of data relating to one or more available resources; and
determining one or more recommended allocations of the one or more available resources for monitoring the plurality of applications based on each set of data received.

20. A computer program product comprising a computer-readable hardware storage medium having program code embodied therewith, the program code being executable by a computer to implement a method comprising:
receiving a first set of data relating to a plurality of applications to be monitored, wherein the first set of data includes unstructured data;
receiving a second set of data relating to one or more available resources; and
determining one or more recommended allocations of the one or more available resources for monitoring the plurality of applications based on each set of data received.
